(19) United States
(12) Patent Application Publication
(10) Pub. No.: US 2025/0209486 A1
(43) Pub. Date: Jun. 26, 2025

(54) SYSTEM AND METHOD FOR MANAGING REFERRAL COMPETITION USING LEADERBOARD

(71) Applicant: Brian Christopher Brewer, West Bloomfield, MI (US)

(72) Inventor: Brian Christopher Brewer, West Bloomfield, MI (US)

(21) Appl. No.: 18/395,677

(22) Filed: Dec. 25, 2023

(51) Int. Cl. G06Q 30/0214

(52) U.S. Cl. CPC G06Q 30/0214

(57) ABSTRACT

The disclosed system and method enhance referral systems using a dynamic leaderboard, uniquely retaining and accumulating user value. It encourages active participation by both referrers and referees. Referrers initiate the process, and both parties earn points for successful referrals, visible on a real-time leaderboard. The system uniquely retains value within its framework, enabling users to accumulate and carry forward points, fostering sustained engagement and long-term user investment. This retention of value enhances user experience, incentivizes continuous participation, and strengthens user loyalty. The method and system provide a flexible and engaging way to manage referral competitions, fostering a competitive yet collaborative environment.

### TECHNICAL FIELD

The present disclosure relates to the field of referral-competition, specifically to a system and a method for managing the referral competition using a leaderboard in real-time.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Typically, a leaderboard is commonly used to assess performance of a user within a particular activity by comparing it to predefined criteria. Its primary function is to recognize and rank the users based on their performance, and showcasing top performers in that activity.

In the digital platform environment, the primary focus is on acquiring new users to participate in a referral competition. One effective method for attracting fresh users has been through a referral system. The referral system encourages existing users to invite new individuals to join the platform. Common rewards for participants include cash incentives, discounts, or access to premium features. However, the existing referral system comes with several drawbacks: (a) some systems often rely on a single incentive mechanism, which typically rewards the referrer, potentially limiting the motivation for both parties to actively participate, (b) there is a lack of an ongoing engagement, as users may lose interest once they have referred a specific number of people, especially if there are no additional incentives for continued engagement. One-time rewards may fail to promote long-term interaction, (c) the system lacks flexibility since fixed rewards are offered regardless of the referred user's quality or activity level. This leads to a failure in distinguishing between the users who refer many inactive users and those who refer fewer but more active ones, (d) the system lacks a public ranking mechanism or a visual representation of potential rewards. Without a competitive element, the users may lack the motivation to outperform others, and (e) the system implements expiration of points or rewards, if they are not used within a certain timeframe, which can discourage the users from accumulating points or remaining engaged.

Given these limitations, there is a need for an improved referral system that provides dual incentives, promotes continuous engagement, establishes transparency through a leaderboard, and allows the users to retain their accumulated points. Such enhancements are crucial for maintaining a sustained user interest and facilitating organic platform growth.

### Objects of the Present Disclosure

A general object of the present disclosure is to provide a system and method for managing the referral competition using a leaderboard in real-time.

An object of the present disclosure is to provide a system and a method that encourages existing participants (referrers) to invite new participants (referees) into the referral competition, with an incentive of receiving an award upon meeting a certain criteria.

An object of the present disclosure is to provide a system and a method for incentivizing the users to refer other users to participate in the referral competition.

An object of the present disclosure is to provide a system and a method for acknowledging the users by retaining their award points even if they do not secure a top position in the referral competition.

An object of the present disclosure is to provide a system and a method for consistently and dynamically updating the leaderboard to reflect the user's positions based on their accrued points.

An object of the present disclosure is to provide a system and a method for enabling the users who have secured top positions on the leaderboard to claim the awards.

An object of the present disclosure is to provide a system and a method where the earned reward points of the user remains valuable and may be utilized in upcoming contests or exchanged for a range of perks, which may include discounts, early access to new features, or participation in exclusive contents.

### SUMMARY

Aspects of the present disclosure relate to the field of referral-competition, and specifically to a system and a method for managing the referral-competition using the leaderboard in real-time.

An aspect of the present disclosure pertains to a method for managing a referral competition using a leaderboard. The method comprises: initiating, at a processor configured to an electronic device, a successful participation by a referrer for the referral competition, where the successful participation is associated with a disclosure of an award to be presented on completion of a specific target within a pre-defined time frame, and wherein a list of awards are displayed on the leaderboard. The method includes promoting, at the processor, a referral scheme to a referee by the referrer, for participation in the referral competition. In addition, the method includes assigning, at the processor, one or more award points to the referrer and the referee, based on the successful participation by the referee in the referral competition, wherein on the successful participation by the referee, the leaderboard is displayed to the referee, and the one or more assigned award points are displayed on the leaderboard.

In an aspect, the method further comprises: accumulating, at the processor, for each of the referrer and the referee, the awarded one or more award points; and updating, at the processor, the leaderboard at regular pre-defined time intervals to display, in a descending order, respective positions of each of the referrer and the referee, based on the accumulated one or more award points.

In another aspect, the method comprises: ranking, at the processor, each of the referrer and the referee, based on the accumulated one or more award points; displaying, at the processor, one of the highest ranked referrer and the referee on the leaderboard; and awarding, at the processor, the disclosed award to one of the highest ranked referrer and the referee for completion of the specific target within the pre-defined time frame.

In another aspect, the method comprises selecting, at the processor, a highest-referring invitee of each of the awarded one of highest ranked referrer and the referee for a distinct reward, based on referral activities of the invitee.

In yet another aspect, the method further comprises generating, at the processor, a completion signal for the referral competition, on the awarding of disclosed award to one of the highest ranked referrer and the referee.

In another aspect, the method comprises retaining, at the processor, the awarded one or more award points for each of the referrer and the referee, despite of at least the closure of the referral competition, and on losing the disclosed award.

In another aspect, the method further comprises assigning, at the processor, additional award points to the referee and the another referee on completion of pre-defined transactions by the another referee.

In yet another aspect, the method further comprises inviting, at the processor, the referee using any of a Short Message Service (SMS), an email, and social media, to participate in the referral competition.

An aspect of the present disclosure pertains to a system for managing a referral competition using a leaderboard, the system comprising: a processor configured to an electronic device and coupled with a memory, wherein the memory stores one or more instructions executable by the processor to initiate a successful participation by a referrer for the referral competition, where the successful participation is associated with a disclosure of an award to be presented on completion of a specific target within a pre-defined time frame, and wherein the list of awards are displayed on the leaderboard. The processor promotes a referral scheme to a referee by the referrer, for participation in the referral competition. Further, the processor assigns one or more award points to the referrer and the referee, based on the successful participation by the referee in the referral competition, wherein on the successful participation by the referee, the leaderboard is displayed to the referee, and the one or more assigned award points are displayed on the leaderboard.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary block diagram representation of a network architecture implementing a proposed referral competition management system for managing a referral competition using a leaderboard, in accordance with an embodiment of the present disclosure.

FIG. 2 illustrates exemplary functional units of the referral competition management system, in accordance with an exemplary embodiment of the present disclosure.

FIG. 3 illustrates an exemplary referral send out, in accordance with an embodiment of the present disclosure.

FIG. 4 illustrates an exemplary representation of the leaderboard showing ranks of a referrer and a referee at a particular time instance, in accordance with an embodiment of the present disclosure.

FIG. 5 illustrates an exemplary representation of the leaderboard when a timer has expired, in accordance with an embodiment of the present disclosure.

FIGS. 6A-B illustrates an exemplary mini entry block and a main entry block respectively, in accordance with an embodiment of the present disclosure.

FIG. 7 illustrates an exemplary representation of all the entries on the leaderboard, in accordance with an embodiment of the present disclosure.

FIG. 8 is a block diagram representing a workflow for ranking and displaying the referrer and the referee on the leaderboard with respect to their respective award points, in accordance with an embodiment of the present disclosure.

FIG. 9 is a block diagram representing a workflow for ranking the referrer and a highest-referring invitee of the referrer on the leaderboard with respect to their respective award points in accordance with an embodiment of the present disclosure.

FIG. 10 is a visual representation depicting an increasing count of participants using the referral competition management system, in accordance with an embodiment of the present disclosure.

FIG. 11 is a flow diagram depicting the proposed method for managing the referral competition using the leaderboard, in accordance with an embodiment of the present disclosure.

FIG. 12 illustrates an exemplary computer system in which or with which embodiments of the present disclosure may be implemented.

The foregoing shall be more apparent from the following more detailed description of the invention.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured”, and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The disclosed system and method facilitates to address various issues of existing referral competition management systems. The issues may be such as (a) absence of dual incentives, some systems often rely on a single incentive mechanism, which may potentially reduce motivation for comprehensive participation; (b) intermittent engagement, where the referrer or the referred user are rewarded in ways that do not promote continuous or prolonged user engagement; and (c) forfeiture of points or rewards, as the available referral systems implement expiration periods for the points or rewards, resulting in user dissatisfaction and reduced participation.

Various embodiments of the present disclosure provides a system and a method for managing the referral competition using a leaderboard. The disclosed system and method facilitates to implement a dual-reward mechanism, where both the referrer and the referred user earns reward points, and have a shared interest in actively participating in the competition. This approach enhances overall user engagement and increases the probability of successful referrals. In addition, the disclosed system and method facilitates to provide a sustained engagement with the leaderboard that showcases the standings of the users. Further, the award points accrued by the user do not expire and hence the users are motivated to stay engaged for an extended period. In addition, the users can track their progress and are inspired to climb the ranks, even if they do not win a prize in a particular referral competition.

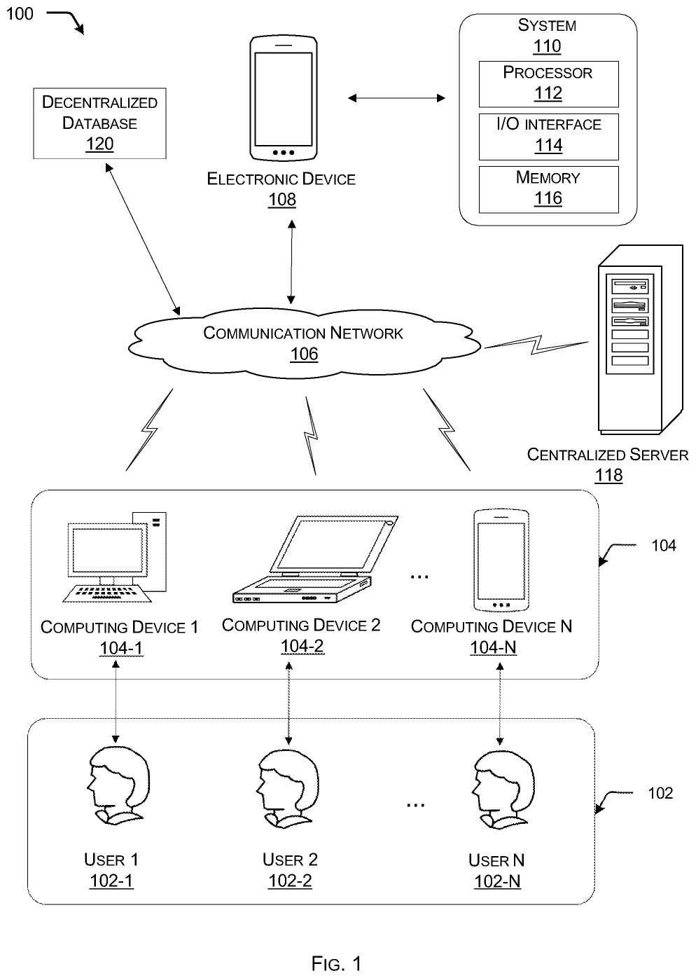

FIG. 1 illustrates an exemplary block diagram representation of a network architecture implementing a proposed referral competition management system for managing the referral competition using the leaderboard, according to embodiments of the present disclosure. The network architecture 100 may include the referral competition management system 110 (also referred to as system 110, herewith), an electronic device 108, a centralized server 118, a decentralized database 120. The system 110 may be communicatively connected to the centralized server 118, and the decentralized database (or node(s)) 120, via a communication network 106. The centralized server 118 may include, but is not limited to, a stand-alone server, a remote server, a cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 106 may be a wired communication network or a wireless communication network. The wireless communication network may be any wireless communication network capable of transferring data between entities of that network such as, but is not limited to, a carrier network including a circuit-switched network, a public switched network, a Content Delivery Network (CDN) network, a Long-Term Evolution (LTE) network, a New Radio (NR), a Global System for Mobile Communications (GSM) network and a Universal Mobile Telecommunications System (UMTS) network, an Internet, intranets, Local Area Networks (LANs), Wide Area Networks (WANs), mobile communication networks, combinations thereof, and the like.

The system 110 may be implemented by way of a single device or a combination of multiple devices that may be operatively connected or networked together. For example, the system 110 may be implemented by way of a standalone device such as the centralized server 118 (and/or a decentralized server or node(s)), and the like, and may be communicatively coupled to the electronic device 108. In another example, the system 110 may be implemented in/associated with the electronic device 108. In yet another example, the system 110 may be implemented in/associated with respective computing device 104-1, 104-2, . . . , 104-N (individually referred to as computing device 104, and collectively referred to as computing devices 104), associated with one or more user 102-1, 102-2, . . . , 102-N (individually referred to as the user 102, and collectively referred to as the users 102). In such a scenario, the system 110 may be replicated in each of the computing devices 104. The users 102 may be a user of, but are not limited to, an electronic commerce (e-commerce) platform, a hyperlocal platform, a super-mart platform, a media platform, a service providing platform, a gaming platform, a social networking platform, a messaging platform, a bot processing platform, a virtual assistance platform, an Artificial Intelligence (AI) based platform, and the like. In some instances, the user 102 may include an entity/administrator, a referrer, a referee (also referred to as a referee or another referee herewith), a sender of a referral code and a receiver of the referral code. The electronic device 108 may be at least one of, an electrical, an electronic, an electromechanical, and a computing device. The electronic device 108 may include, but is not limited to, a mobile device, a smart-phone, a Personal Digital Assistant (PDA), a tablet computer, a phablet computer, a wearable device, a Virtual Reality/Augmented Reality (VR/AR) device, a laptop, a desktop, a server, and the like. The system 110 may be implemented in hardware or a suitable combination of hardware and software. The system 110 or the centralized server 118 or the decentralized database 120 may be associated with entities (not shown). The entities may include, but are not limited to, an e-commerce company, a company, an outlet, a manufacturing unit, an enterprise, a facility, an organization, an educational institution, a secured facility, and the like.

Further, the system 110 may include a processor 112, an Input/Output (I/O) interface 114, and a memory 116. The Input/Output (I/O) interface 114 of the system 110 may be used to receive user inputs, from one or more computing devices 104 associated with one or more users 102.

In an embodiment, the system 110 may manage the referral competition using the leaderboard (not shown). The system 110 may include the processor 112 configured to the electronic device 108. The processor 112 may be coupled with the memory 116. The memory 116 may store one or more instructions that are executable by the processor to initiate a successful participation by the referrer for the referral competition. Upon a successful participation by the referrer, an award to be presented on completion of a specific target within a pre-defined time frame may be disclosed. Further, a list of awards to be presented on completion of the competition may be displayed on the leaderboard. The leaderboard may be displayed on a display screen associated with the electronic device 108. In addition, the leaderboard may be displayed on a display device associated with the electronic device 108.

On initiation of the referral competition and for additional user participation, the referrer may promote a referral scheme to a referee. When the referee successfully participates in the referral competition, the award points may be assigned to the referrer and the referee. In addition, the leaderboard may be displayed to the referee and the one or more assigned award points may be displayed on the leaderboard.

In an embodiment, the referrer may invite a referee to participate in the referral competition. The invitation may be shared using any of a Short Message Service (SMS), an email, and social media. On a successful confirmation by the referee to participate in the referral competition, the award points may be assigned to each of the referrer and the referee. Also, the awarded award points may be displayed on the leaderboard. Further, the system 110 may accumulate the awarded award points for each of the referrer, and the referee. Based on the accumulated award points, the leaderboard may be updated at regular pre-defined time intervals to display respective positions of each of the referrer and the referee, in a descending order.

Based on the accumulated one or more award points, the system 110 may rank each of the referrer and the referee. Details of the one who is ranked the highest may be displayed on the leaderboard. Further, the disclosed award may be awarded to the one of the highest ranked referrer and the referee for completion of the specific target within the pre-defined time frame.

In an embodiment, the disclosed award may be awarded to one of the highest ranked referrer and the referee for completion of the specific target within the pre-defined time frame. In addition, a highest-referring invitee of each of the one of highest ranked referrer and the referee may be awarded a distinct reward, based on referral activities of the invitee.

In an embodiment, on awarding the disclosed award to one of the highest ranked referrer and the referee, a completion signal may be generated for the referral competition.

In an embodiment, despite the closure of the referral competition, and on losing the disclosed award, the awarded one or more award points may be retained for each of the referrer and the referee.

In an embodiment, additional award points may be awarded to the referee on completion of pre-defined transactions by another referee. The pre-defined transactions may include such as additional purchases or transactions done by the another referee.

In some implementations, the system 110 may include data, and modules. As an example, the data may be stored in the memory 116 configured in the system 110. In an embodiment, the data may be stored in the memory in the form of various data structures. Additionally, the data may be organized using data models, such as relational or hierarchical data models.

In an embodiment, the data stored in the memory 116 may be processed by the modules of the system 110. The modules may be stored within the memory. In an example, the modules communicatively coupled to the processor configured in the system, may also be present outside the memory, and implemented as hardware. As used herein, the term modules refer to an Application-Specific Integrated Circuit (ASIC), an electronic circuit, a processor (shared, dedicated, or group) and the memory that execute one or more software or firmware programs, a combinational logic circuit, and/or other suitable components that provide the described functionality.

Further, system 110 may also include other units such as a display unit, an input unit, an output unit, and the like, however the same are not shown in FIG. 1, for the purpose of clarity. Also, in FIG. 1 only a few units are shown, however, the system 110 or the network architecture 100 may include multiple such units or the system 110/network architecture 100 may include any such numbers of the units, obvious to a person skilled in the art or as required to implement the features of the present disclosure. The system 110 may be a hardware device including the processor 112 executing machine-readable program instructions to display ranked positions of the sender and the receiver on the leaderboard.

Execution of the machine-readable program instructions by the processor 112 may enable the system 110 to determine rankings based on entries and display the rankings on the leaderboard in real-time. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors. The processor 112 may include, for example, but are not limited to, microprocessors, microcomputers, microcontrollers, digital signal processors, central processing units, state machines, logic circuits, and any devices that manipulate data or signals based on operational instructions, and the like. Among other capabilities, the processor 112 may fetch and execute computer-readable instructions in the memory 116 operationally coupled with the system 110 for performing tasks such as data processing, input/output processing, and/or any other functions. Any reference to a task in the present disclosure may refer to an operation being or that may be performed on data.

In an embodiment, for participating in the referral competition and promotion of a product, a platform etc., the referrer may send a referral code to the referee via a text messaging application e.g., Short Message Service (SMS), or through other available messaging applications, and the like.

In an exemplary embodiment, the referee may use a referral code to sign in for using a promoted product, a platform or participating in the referral competition. Upon the referrer sending the referral code, and the referee using the referral code both the referrer and the referee may be logged into the leaderboard. Based on how many referees have signed up for using the promoted product or the platform on receiving the referral code from the referrer, the referrer may be credited with award points. Similarly, the referees who may have signed up for using the promoted product or the platform may also be credited with the award points.

By way of an example, the leaderboard may be used for measuring progress/achievement, status, providing a sense of what is possible, and the like. The leaderboard may be used, for example, to represent a sales team, display downloads of software products from a company's website, a winner in a game, and the like. The representation of the leaderboard may be done locally, contextually, or as per time. For example, the referees and the referrer may see their rank in relation to that of others in their geographic area. The leaderboard may show leaders by category, and the leaderboard may be set up to show, for example, weekly or monthly leaders.

In addition, the referrer who may have signed up for using the promoted product or the platform on receiving the referral code may further refer their friends or acquaintances, contacts to sign up for using the promoted product or the platform. If their friends, contacts in turn sign up for using the promoted product or the platform, the referrer in this case may also receive respective referral points. For example, the receivers (e.g. friends, family, and acquaintances) who sign up for the promoted product or platform using the referral code may further refer their friends and earn referral points if their friends also sign up to join the referral competition.

The referee or the referrer may be ranked and displayed on the leaderboard based on their respective award points. The leaderboard may display an image of each of the referee or the referrer along with their ranks in a descending order. The display of the leaderboard may be controlled by a timer. When the timer goes off, the leaderboard may be cleared. Upon re-initiation of the timer, a new leaderboard may be constructed which may display the ranks accordingly. As may be appreciated, the ranks may be determined and altered dynamically in real-time.

As may be appreciated, the referrer or the referee are the users 102. For ease of reference and clarity, the referrer has been referred to as the sender, and the referee have been referred to as the receiver, and this should not be constructed as limiting in any sense thereof in further disclosed sections. In addition, the term—the referee has been used for explanation purposes and should not be considered as limiting to only the receiver invited to the referral competition by the referrer.

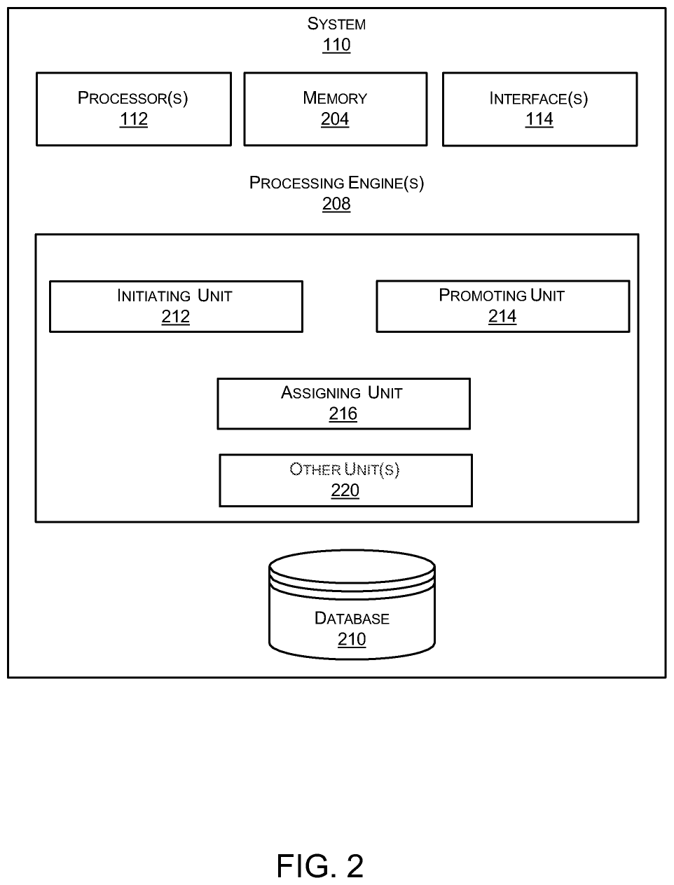

FIG. 2 illustrates exemplary functional units of the proposed system 110, in accordance with an exemplary embodiment of the present disclosure. The system 110 may include the one or more processor(s) 112. The one or more processor(s) 112 may be implemented as one or more microprocessors, microcomputers, microcontrollers, digital signal processors, central processing units, logic circuitries, and/or any devices that manipulate data based on operational instructions. Among other capabilities, the one or more processor(s) 112 are configured to fetch and execute computer-readable instructions stored in a memory 204. The memory 204 may store one or more computer-readable instructions or routines, which may be fetched and executed to create or share the data units over a network service. The memory 204 may include any non-transitory storage device including, for example, volatile memory such as RAM, or non-volatile memory such as EPROM, flash memory, and the like.

In an embodiment, the system 110 may also include an interface(s) 114. The interface(s) 114 may include a variety of interfaces, for example, interfaces for data input and output devices, referred to as I/O devices, storage devices, and the like. The interface(s) 114 may facilitate communication with various other devices coupled to the one or more processor(s) 112. The interface(s) 114 may also provide a communication pathway for one or more components of the one or more processor(s) 112. Examples of such components include, but are not limited to, processing engine(s) 208 and database 210.

In an embodiment, the processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may include a processing resource (for example, one or more processors), to execute such instructions.

In the present examples, the machine-readable storage medium may store instructions that, when executed by the processing resource, implement the processing engine(s) 208. In such examples, the processor(s) 112 may include the machine-readable storage medium storing the instructions and the processing resource to execute the instructions, or the machine-readable storage medium may be separate but accessible to the system 110 and the processing resource. In other examples, the processing engine(s) 208 may be implemented by electronic circuitry. The database 210 may include data that is either stored or generated as a result of functionalities implemented by any of the components of the processing engine(s) 208. In an embodiment, the processing engine(s) 208 may include an initiating unit 212, a promoting unit 214, an assigning unit 216, and other units(s) 220. The other unit(s) 220 may implement functionalities that supplement applications/functions performed by the system 110.

The initiating unit 212 may serve as a catalyst for the referrer to engage effectively in the referral competition. The successful participation of the referrer may trigger unveiling of the award, which may be conferred upon the achievement of a specific goal within the predetermined time frame. Furthermore, the leaderboard may showcase a compilation of awards.

The promoting unit 214 may promote a referral scheme to a referee, by the referrer, for participation in the referral competition. The promoting unit 214 may be tasked with advocating the referral competition to the referee on behalf of the referrer, encouraging their involvement in the referral competition.

Based on the successful participation by the referee in the referral competition, the assigning unit 216 may assign multiple award points to the referrer. On the successful participation by the referee, the leaderboard may be displayed to the referee. Upon the successful engagement of the referee in the referral competition, the assigning unit 216 may allocate multiple award points to the referrer. Additionally, when the referee successfully participates, the leaderboard may be made visible to them.

In another embodiment, the system 110, through the other unit(s) 220, may manage the referral competition using the leaderboard.

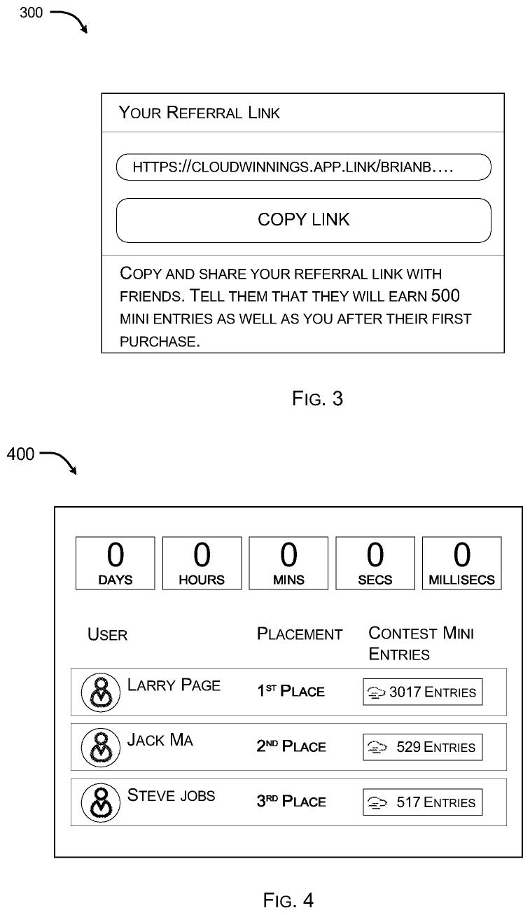

FIG. 3 illustrates an exemplary referral send out 300, in accordance with an embodiment of the present disclosure. With respect to FIG. 3, the referrer may create and send the referral send out 300 to the referee. The distinctive referral send out 300 may be disseminated using various methods, such as automated SMS text messages, broadcast messages, Voice over Internet Protocol (VOIP) texting, through email, and the like.

In an embodiment, the referee may further send a referral send out to the another referee for participating in the referral competition.

As illustrated, the referral send out 300 may provide a direct referral link to connect to the referral competition, the promoted product or the platform. The referee may access the referral competition, the promoted product or the platform through a provided direct referral link. The unique referral send out 300 may also have an option to copy the direct referral link and access the referral competition, the promoted product or the platform. Further, the unique referral send out 300 may include a message conveying the referee to copy and share the direct referral link with their friends/contacts/family. The message may also convey that both the referee and their friends/contacts may earn the award points on purchase/use of the product/the platform respectively. In one implementation, the system 110 may access contact numbers of the referrer/referee to automate the referral link creation process using the electronic device 108.

By way of an example, Maria may get entries for directly inviting Liam (when a required action is made) but may not get entries when Liam invites Sophia (after a required action) or any other subsequent referees. Liam may get entries for joining through Maria's referral (when a required action is made) and for directly inviting Sophia (when a required action is made). Sophia may get entries only for joining the platform from Liam and may start her own referral chain, but her actions may not contribute any entries to Maria.

The user only benefits from their direct referral activities (actions) if they did a required action from someone else's referral or if the person they invited does an action from their referral.

FIG. 4 illustrates an exemplary representation 400 of the leaderboard showing ranks of each of the referrer and the referee at a particular time instance, in accordance with an embodiment of the present disclosure. As is illustrated, is a user section that includes images of each of the referrer and the referees. Next, is shown a placement section that displays the respective ranks attained by each of the referrer and the referees. Another section is a contest mini entries section that displays entries assigned to the referrer and the referee. The entries may be associated with the award points assigned to each of the referrer and the referee. Further, the leaderboard may show additional details with respect to a timer associated with the leaderboard. The details may include and represent, for example, days, hours, minutes, seconds and milliseconds associated with the referral competition on the leaderboard.

By way of an example, the user “Larry page” is shown, who holds a first rank and has 3017 entries i.e., award points. Second rank is held by the user “Jack Ma” having 529 entries. Finally, the user “Steve Jobs” who holds a third rank is displayed and has 517 entries.

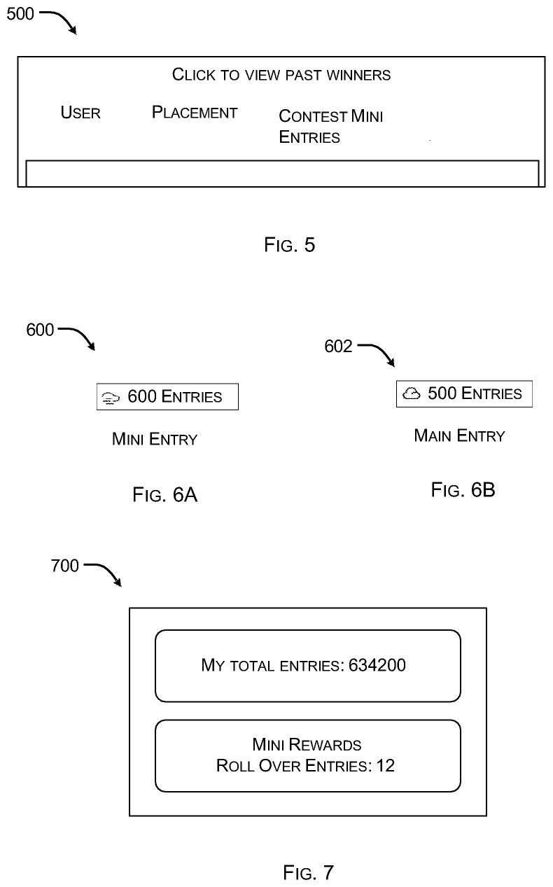

FIG. 5 illustrates an exemplary representation 500 of the leaderboard when the timer has expired, in accordance with an embodiment of the present disclosure. The term expired may refer to a situation when the leaderboard has been cleared after a rank for either the referrer or the referee has been recorded or has been taken into account. With respect to FIG. 5, is displayed an empty leaderboard when the associated timer has expired. As is shown, the leaderboard shows no information in the user section, the placement section, or the contest mini entries section. Further, the empty leaderboard includes a section to view past winners on the platform. In an embodiment, the completion signal may be generated on completion of the referral competition and the leaderboard may be cleared thereof.

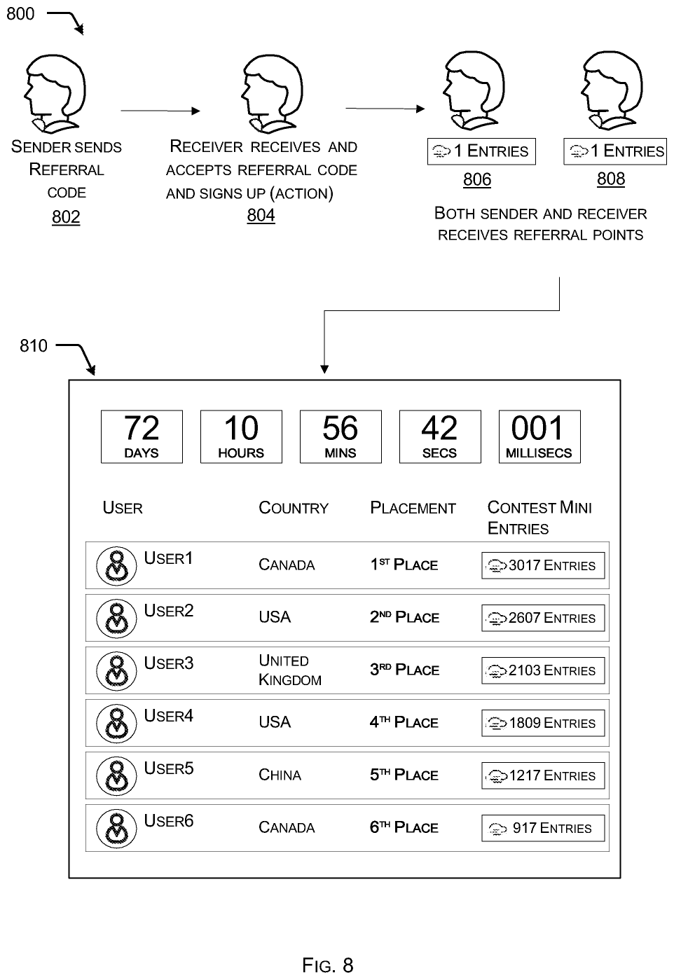

FIGS. 6A-B illustrates an exemplary mini entry block 600 and a main entry block 602 respectively, in accordance with an embodiment of the present disclosure. In an embodiment, the main entries 602 may be the entries that may be required by the user to win the disclosed award. However, the mini entries 600 or mini rewards may represent the award points that the user may achieve for actions performed while participating in the referral competition.

In an exemplary scenario, when a user e.g., the referrer does not win the disclosed award then the main entries may be converted to the mini entries. It may be noted that the reward points represented as the mini entries or the mini rewards may never get deleted or destroyed and may always keep adding up. As is illustrated, information in the main entry block 602, and information in the mini entry block 600 may refer to the referral points assigned to each of the referrer and the referee. Further, the information in each of the main entry block 602 and the mini entry block 600 may be maintained in the decentralized database 120. Furthermore, the information of the mini entry block 600 may be displayed on the leaderboard in the contest mini entries section.

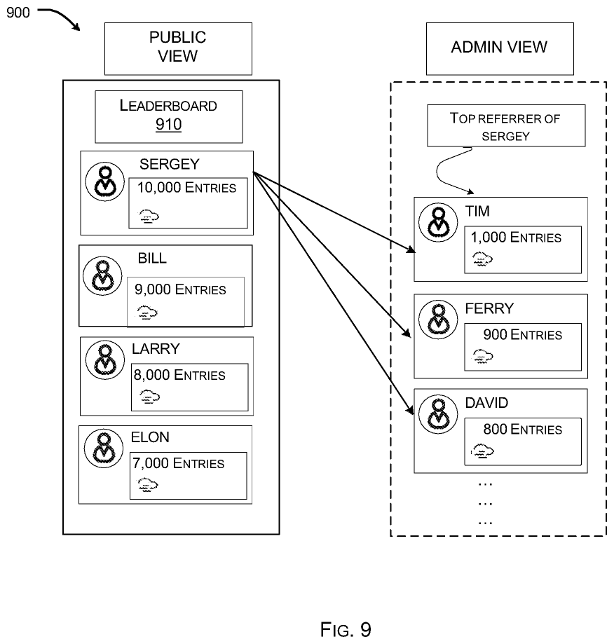

FIG. 7 illustrates an exemplary representation 700 of all the entries, for the user, on the leaderboard, in accordance with an embodiment of the present disclosure. By way of an example, is displayed the entry with respect to the user, for example, the referrer. For the users the entries may be shown as, for example, as “My Total Entries”, and as “Mini Rewards”.

The “My Total Entries” include, for example, 634200 entries and the “Mini Rewards” include, say 12 Roll-Over Entries. The displayed “My Total Entries” and the “Mini Rewards” are maintained in any of the decentralized database 120 or the centralized server 118.

FIG. 8 is a block diagram representing a workflow for ranking and displaying the referrer 802 and the referee 804 on the leaderboard 810 with respect to their respective award points in accordance with an embodiment of the present disclosure. As is illustrated, the referrer 802 may send the referral code to the referee 804 for promotion of the product or the platform. The referral code may be sent via the messaging application, for example, the SMS, and the like. The referee 804 may accept the referral code and sign up for trying/using the promoted product or the platform. When the referee 804 accepts the referral code and signs up, both the referrer 802 and the referee 804 may be each assigned the award points 806 and 808 respectively. Further, based on their assigned respective referral points, the referrer 802 and the referee 804 may be assigned positions on the leaderboard 810. The positions may be assigned in the descending order of the assigned award points.

As is illustrated, a user 1, from Canada, holds a first place on the leaderboard 810 with 3017 contest entries. User 2, from the USA, holds a second place with 2607 contest entries, and so on. The user 1, the user 2, and the like may be ranked and displayed on the leaderboard 810 until the timer stops or a time period for the referral competition is over and the user 1 is declared as winner(s) from amongst the users listed on the leaderboard 810, as the User 1 has the highest number of the award points.

When the timer expires, the leaderboard 810 may be cleared and all the listed users on the leaderboard 810 may be removed. Further, on re-initiation of the timer a new set of users with their respective codes may be listed and placed as per their positions on the leaderboard 810. By way of an example, if two or more of the users have the same number of entries when the timer runs out and the leaderboard 810 freezes, the user that has achieved the highest award points first in the real-time may be rewarded a higher position.

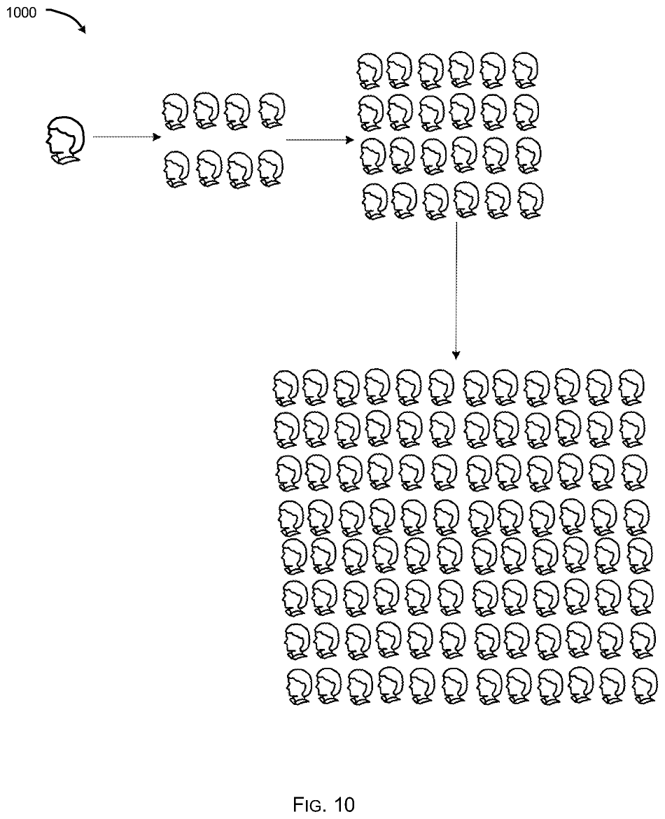

FIG. 9 is a block diagram 900 representing a workflow for ranking the referrer and a highest-referring invitee of the referrer with respect to their respective award points, in accordance with an embodiment of the present disclosure.

When a user joins the platform through a website or an application, he may invite his friends to sign up. Upon inviting his friends he may become a referrer. When a friend performs a specific action, such as making a purchase or completing a particular task, the original referrer and the friend (i.e., new user) may both earn 500 ‘Mini entries.’ These entries are crucial for boosting each of the referrer's and his friend's standings on a real-time leaderboard 910.

Consider the case of Sergey, who brings Tim onto the platform. After Tim completes a qualifying action, both Sergey and Tim are awarded 500 Mini entries. Although Tim's ranking is not high enough for public leaderboard visibility, the data reveals a significant detail that he is the primary referrer for someone who is on the leaderboard. Among all of Sergey's referrals, Tim ranks at the top, surpassing others like Ferry and David. Recognizing Tim's pivotal role in network growth, he becomes eligible for an additional reward. This approach not only recognizes the unique contributions of each individual but also acts as a powerful driver for the platform's expansion. It provides incentives for increased user engagement and encourages referrals, ultimately expediting growth and enriching the diversity of a user base.

It may be noted that the leaderboard is governed by a countdown clock, right down to the millisecond. When the clock stops, the leaderboard snapshot becomes final, locking in the ranks of the participants. Further, winners are determined, and prizes are awarded in a descending order. As may be appreciated, the participants who do not win are not at a loss, because Mini entries are maintained for future redemptions thus incentivizing continuous community support.

In an embodiment, the participants may have unique referral links for promotion to potential new users. Post-competition, the leaderboard may be reset, allowing each of the participants to start fresh in the race against the clock for the next round of rewards.

However, the leaderboard displays only the top 50 Mini entry earners. Despite this, the system's backend (i.e. Database 210) tracks all activity, enabling to reward unseen, yet significant contributors. For instance, Sergey, with a high engagement level, invited friends and family, including Ferry (who invited the second most number of people with respect to Sergey's invite). However, in spite of 900 entries Ferry did not make it to the public leaderboard. The system ensures that top referrers of the referrers may receive recognition and rewards, reflecting the value they bring to the platform's growth. This dual system of public recognition and backend acknowledgment ensures that every contributor, visible or not, is valued and incentivized to keep engaging.

The disclosed system and method recognizes the highest-referring invitee (i.e. the top performers) because that helps to create an incentive for the participants to drive and create additional competition to drive the referral system forward. Existing referral competition mechanisms often lack this motivating element, and without such mechanisms the referral competition may be inefficient. This is because, if the referrer is significantly ahead, the participants that he invites may not have a compelling reason to refer other participants to the platform or the competition.

FIG. 10 is a visual representation 1000 depicting an increasing count of participants using the referral competition management system, in accordance with an embodiment of the present disclosure.

The displayed sequence may commence with a solitary participant i.e., a single participant and may progressively evolve as an expanded group of rapid viral growth, showcasing a substantial number of the participants. The visual representation exemplifies efficiency of the disclosed system and method, thus providing a concrete proof of its effectiveness to observe a substantial growth of the number of the participants in the system.

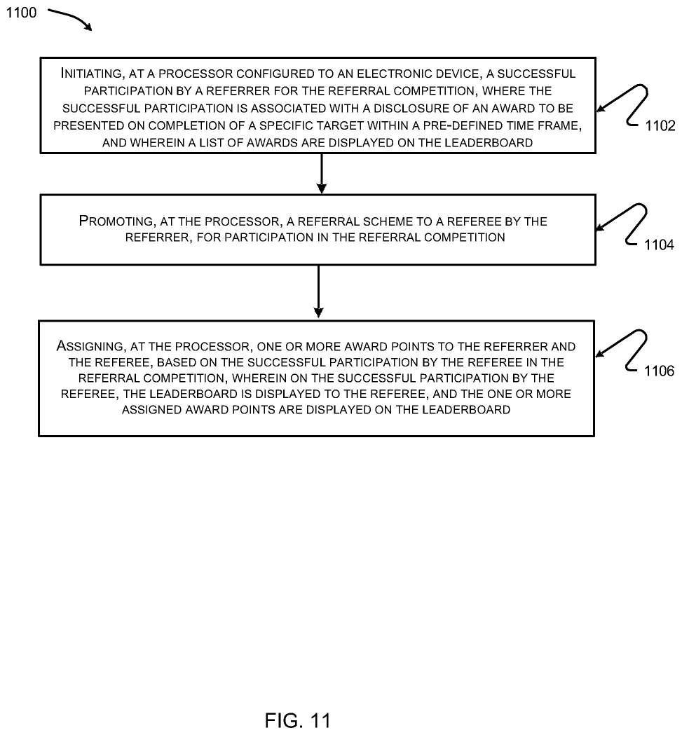

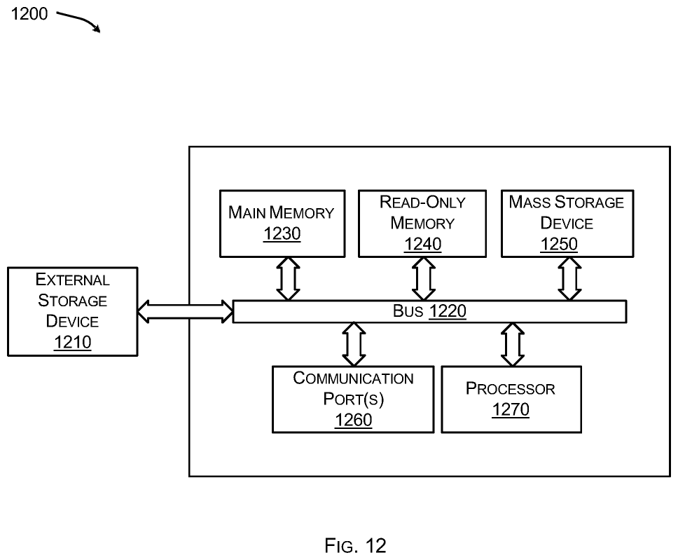

FIG. 11 is a flow diagram 1100 depicting the proposed method for managing the referral competition using the leaderboard, in accordance with an embodiment of the present disclosure. The disclosed system and method facilitates to manage the referral competitions using the leaderboard thus enhancing user engagement and involvement. Fundamentally, the disclosed system and method incentivizes the users to refer others, while incorporating several distinctive elements. These include awarding dual rewards, retention of earned points, and use of the leaderboards to create a competitive and visually engaging experience.

At step 1102, a successful participation by the referrer may be initiated for the referral competition. Successful participation may be associated with the disclosure of the award to be presented on completion of the specific target within a pre-defined time frame. In addition, the list of awards may be displayed on the leaderboard.

By way of an example, when the users first join the referral competition, they may begin by creating an account, and as they do so, they may be immediately introduced to the leaderboard. For example, upon registering on the platform, a referrer, say Maria may be greeted with a video presentation featuring a brand-new smartphone as the award. The timer on the leaderboard may prominently display that she has a 30-day window to ascend the leaderboard.

For participation in the referral competition, at step 1104, a referral scheme may be promoted to a referee by the referrer. This may be done by using any of the Short Message Service (SMS), email, social media, and the like. For example, Maria may decide to refer her friend Liam through email.

Further, based on the successful participation by the referee in the referral competition, at step 1106, one or more award points may be assigned to the referrer. On successful participation by the referee, the leaderboard may be displayed to the referee. For example, upon receiving the invitation, when Liam successfully registers and takes additional actions in the referral competition, both Maria and Liam may be rewarded with 50 points each.

As may be appreciated, the additional award points may be assigned to each of the referee and the another referee on completion of pre-defined transactions by the another referee. Continuing with the example, let's say Liam, after being referred by Maria, invites Sophia (i.e., another referee) and Sophia makes a purchase on the platform. This action may result in both Liam and Sophia receiving an additional 20 points each.

As may be appreciated, Maria may get entries for directly inviting Liam (when a required action is made) but may not get entries when Liam invites Sophia (after a required action) or any other subsequent referees.

Further, based on the accrued award points, the leaderboard may be consistently and dynamically updated to reflect the position of each of the users. This transparency may create a competitive atmosphere, thus motivating the users to enhance their referral activities in order to ascend the rankings. For instance, Ferry may realize that he is currently in the 2th position on the leaderboard, and he is only 100 points away from reaching the 1st position. This realization may inspire him to refer a few more friends in an effort to move higher up on the leaderboard.

At the conclusion of the referral competition, the users who secure top positions on the leaderboard may be eligible to claim the awards that were showcased. It is to be appreciated, that not only the top referrer but also those users referred by the top referrer may have a potential to win rewards, thus acknowledging a collective engagement they have contributed to the competition. For instance, at the end of the 30-day period, Ferry finishes in 2nd place on the leaderboard, earning the featured smartphone. Further, because Tim, who was referred by Sergey, successfully invited the highest number of new users among Sergey's referrals, he also may secure a special prize in recognition of his achievements.

The awarded one or more award points may be retained for each of the referrer and the referee, despite of at least the closure of the referral competition and on losing the disclosed award. One significant benefit of the disclosed system and method is that the users who do not manage to secure a top position on the leaderboard do not lose their hard-earned award points. These points remain valuable and may be utilized in upcoming contests or may be exchanged for a range of perks, which may include discounts, early access to new features, or exclusive content. As may be appreciated, the award points may be stored in the decentralized database 120.

For instance, consider Elon, who, despite referring numerous friends, ends up in 4th position and does not secure the main prize in the current contest. Nonetheless, his accrued award points may provide him with an advantage of potentially winning prizes in future contests or enjoying discounts at a later date.

The system 110 acknowledges efforts of the users, and their hard-earned award points are never forfeited, even if they do not secure top positions. This persistent point retention mechanism guarantees that their dedication for participation in the referral competition is continuously valued. Beyond merely motivating them to partake in future contests, these retained award points may be employed to access extra advantages and privileges on the platform. These perks might encompass exclusive content, discounts, or early access to features. This dual advantage of both promoting ongoing engagement and offering tangible rewards fosters a profound sense of fairness in the referral competition. The users of the system may become more deeply connected and appreciated thus enhancing their overall experience.

Those skilled in the art would appreciate that embodiments of the present disclosure provides the leaderboard where each of the referrer and the referee may be ranked based on their assigned respective award points. In one example, each of the referrer and the referee may be ranked based on their assigned respective award points, in a descending order. The embodiments of the present disclosure rewards each of the referrer and the referee based on their respective referral points along with providing monetary rewards or non-monetary rewards.

FIG. 12 illustrates an exemplary computer system 1200 in which or with which embodiments of the present disclosure may be implemented. As shown in FIG. 12, the computer system 1200 may include an external storage device 1210, a bus 1220, a main memory 1230, a read-only memory 1240, a mass storage device 1250, communication port(s) 1260, and a processor 1270. A person skilled in the art will appreciate that the computer system 1200 may include more than one processor and communication ports. The processor 1270 may include various modules associated with embodiments of the present disclosure. The communication port(s) 1260 may be any of an RS-232 port for use with a modem based dialup connection, a 10/100 Ethernet port, a Gigabit or 10 Gigabit port using copper or fiber, a serial port, a parallel port, or other existing or future ports. The communication port(s) 1260 may be chosen depending on a network, such a Local Area Network (LAN), Wide Area Network (WAN), or any network to which the computer system 1200 connects. The main memory 1230 may be random access memory (RAM), or any other dynamic storage device commonly known in the art. The read-only memory 1240 may be any static storage device(s) e.g., but not limited to, a Programmable Read Only Memory (PROM) chips for storing static information e.g., start-up or BIOS instructions for the processor 1270. The mass storage device 1250 may be any current or future mass storage solution, which can be used to store information and/or instructions. Exemplary mass storage device 1250 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 1220 communicatively couples the processor 1270 with the other memory, storage, and communication blocks. The bus 1220 may be, e.g. a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 1270 to the computer system 1200.

Optionally, operator and administrative interfaces, e.g. a display, keyboard, joystick, and a cursor control device, may also be coupled to the bus 1220 to support direct operator interaction with the computer system 1200. Other operator and administrative interfaces can be provided through network connections connected through the communication port(s) 1260. Components described above are meant only to exemplify various possibilities. In no way should the aforementioned exemplary computer system 1200 limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and method for encouraging existing participants (referrers) to invite new participants (referees) into the referral competition, with an incentive of receiving an award upon meeting certain criteria.

The present disclosure provides a system and method for incentivizing users to refer others to participate in the referral competition.

The present disclosure provides a system and method for acknowledging the users by retaining their award points even if they do not secure a top position.

The present disclosure provides a system and method for consistently and dynamically updating the leaderboard to reflect the users' positions based on their accrued points.

The present disclosure provides a system and method for enabling the users who have secured top positions on the leaderboard to claim the awards.

The present disclosure provides a system and method where the earned reward points of the user remains valuable and may be utilized in upcoming contests or exchanged for a range of perks, which may include discounts, early access to new features, or participation in exclusive content.

We claim:

1. A method for managing a referral competition using a leaderboard, the method comprising:
initiating, at a processor configured to an electronic device, a successful participation by a referrer for the referral competition, where the successful participation is associated with a disclosure of an award to be presented on completion of a specific target within a pre-defined time frame, and wherein a list of awards are displayed on the leaderboard;
promoting, at the processor, a referral scheme to a referee by the referrer, for participation in the referral competition; and
assigning, at the processor, one or more award points to the referrer and the referee, based on the successful participation by the referee in the referral competition, wherein on the successful participation by the referee, the leaderboard is displayed to the referee, and the one or more assigned award points are displayed on the leaderboard.

2. The method as claimed in claim 1, wherein the method further comprises:
accumulating, at the processor, for each of the referrer and the referee, the awarded one or more award points; and
updating, at the processor, the leaderboard at regular pre-defined time intervals to display, in a descending order, respective positions of each of the referrer and the referee, based on the accumulated one or more award points.

3. The method as claimed in claim 2, wherein the method further comprises:
ranking, at the processor, each of the referrer and the referee, based on the accumulated one or more award points;
displaying, at the processor, one of the highest ranked referrer and the referee on the leaderboard; and
awarding, at the processor, the disclosed award to one of the highest ranked referrer and the referee for completion of the specific target within the pre-defined time frame.

4. The method as claimed in claim 3, wherein the method further comprises:
selecting, at the processor, a highest-referring invitee of each of the awarded one of highest ranked referrer and the referee for a distinct reward, based on referral activities of the invitee.

5. The method as claimed in claim 3, wherein the method further comprises:
generating, at the processor, a completion signal for the referral competition, on the awarding of disclosed award to one of the highest ranked referrer and the referee.

6. The method as claimed in claim 4, wherein the method further comprises:
retaining, at the processor, the awarded one or more award points for each of the referrer and the referee, despite of at least the closure of the referral competition, and on losing the disclosed award.

7. The method as claimed in claim 1, wherein the method further comprises:
assigning, at the processor, additional award points to each of the referee and another referee on completion of pre-defined transactions by the another referee.

8. The method as claimed in claim 1, wherein the method further comprises:
inviting, at the processor, the referee using any of a Short Message Service (SMS), an email, and social media, to participate in the referral competition.

9. A system for managing a referral competition using a leaderboard, the system comprising:
a processor configured to an electronic device and coupled with a memory, wherein the memory stores one or more instructions executable by the processor to:
initiate a successful participation by a referrer for the referral competition, where the successful participation is associated with a disclosure of an award to be presented on completion of a specific target within a pre-defined time frame, and wherein the list of awards are displayed on the leaderboard;
promote a referral scheme to a referee by the referrer, for participation in the referral competition; and
assign one or more award points to the referrer and the referee, based on the successful participation by the referee in the referral competition, wherein on the successful participation by the referee, the leaderboard is displayed to the referee.

10. The system as claimed in claim 9, wherein the processor is configured to:
accumulate the awarded one or more award points for the referrer and the referee; and
update the leaderboard at regular pre-defined time intervals to display, in a descending order, respective positions of each of the referrer and the referee, based on the accumulated one or more award points.

11. The system as claimed in claim 10, wherein the processor is configured to:
rank each of the referrer and referee, based on the accumulated one or more award points;
display one of the highest ranked referrer and the referee on the leaderboard; and
award the disclosed award to one of the highest ranked referrer and the referee for completion of the specific target within the pre-defined time frame.

12. The system as claimed in claim 11, wherein the processor is configured to:
select a highest-referring invitee of each of the awarded one of highest ranked referrer and the referee for a distinct reward, based on referral activities of the invitee.

13. The system as claimed in claim 11, wherein the processor is configured to:
generate a completion signal for the referral competition, on the awarding of disclosed award to one of the highest ranked referrer and the referee.

14. The system as claimed in claim 12, wherein the processor is configured to:
retain the awarded one or more award points for each of the referrer, and the referee, despite of at least the closure of the referral competition, and on losing the disclosed award.

15. The system as claimed in claim 9, wherein the processor is configured to assign additional award points to each of the referee and another referee on completion of pre-defined transactions by the another referee.

16. The system as claimed in claim 9, wherein the processor is configured to invite the referee using any of a Short Message Service (SMS), an email, and social media, to participate in the referral competition.
